(19) United States
(12) Patent Application Publication
(10) Pub. No.: US 2014/0146443 A1
(43) Pub. Date: May 29, 2014

(54) POINT-OF-SERVICE DEVICE AND ADJUSTABLE CONNECTING SEAT THEREOF

(71) Applicant: FLYTECH TECHNOLOGY CO., LTD, Taipei City (TW)

(72) Inventor: MING-WEI KUO, Taipei City (TW)

(73) Assignee: FLYTECH TECHNOLOGY CO., LTD, Taipei City (TW)

(21) Appl. No.: 13/788,012

(22) Filed: Mar. 7, 2013

(30) Foreign Application Priority Data
Nov. 26, 2012 (TW) 101222871

(51) Int. Cl. F16M 11/10

(52) U.S. Cl. CPC F16M 11/10
USPC 361/679.01

(57) ABSTRACT

An adjustable connecting seat is connected with a point-of-service display. The adjustable connecting seat includes a base, a rotating mechanism, and a supporting mechanism. The rotating mechanism includes a first disk and a second disk. The first disk and the second disk are rotatable relative to each other. The second disk is fixed on the base. The supporting mechanism is connected with the rotating mechanism and the point-of-service display. Consequently, the point-of-service display is rotatable by the rotating mechanism.

### FIELD OF THE INVENTION

The present invention relates to an adjustable connecting seat, and more particularly to an adjustable connecting seat for adjusting a rotating angle, a vertical orientation and an altitude of a point-of-service display.

### BACKGROUND OF THE INVENTION

With the advancement of science and technology, the concepts of smart cards such as credit cards, debit cards and stored-value cards have been gradually and widely adopted. Consequently, the demands on the number of point-of-service (POS) devices are increased. For example, point-of-service devices with display screens are usually placed on cash desks of many business places.

Conventionally, a connecting seat of the point-of-service device usually has a fixed length, and is fixed at a specified position such as a cash desk or a wall. In other words, the display screen of the point-of-service device is always oriented at a specified rotating angle, a specified vertical orientation and a specified altitude. In practice, the layout spaces of the point-of-service devices at different business places are usually different. Since the connecting seat of the conventional point-of-service device is unable to be adjusted, the conventional point-of-service device is installed with difficulty because many possible problems should be taken into considerations. After the point-of-service device is installed at a place, the fixed connecting seat of the point-of-service device becomes hindrance from operating the point-of-service device. For example, since different cashiers may have different heights, the fixed altitude of the point-of-service device fails to comply with the suitable viewing angles of all cashiers. In other words, the operations of the conventional point-of-service device are not user-friendly.

For solving the above drawbacks, a point-of-service device for providing axial rotation is disclosed in U.S. Pat. No. 5,569,895 for example. However, the rotating mechanism of the point-of-service device is very complicated, and only the horizontal rotation is allowable. Consequently, the performance of the axial rotation of this point-of-service device is still unsatisfied.

Therefore, there is a need of providing a point-of-service device with an adjustable connecting seat in order to obviate the drawbacks encountered from the prior art. The applicant keeps on carving unflaggingly to develop an improved and reasonable product through wholehearted experience and research.

### SUMMARY OF THE INVENTION

The present invention provides an adjustable connecting seat of a point-of-service device. The adjustable connecting seat is configured for adjusting a rotating angle, a vertical orientation and an altitude of a point-of-service display of the point-of-service device in order to comply with the requirements of different users and different situations.

In accordance with an aspect of the present invention, there is provided an adjustable connecting seat. The adjustable connecting seat is connected with a point-of-service display. The adjustable connecting seat includes a base, a rotating mechanism, and a supporting mechanism. The base has a first surface and a second surface, wherein the second surface is opposed to the first surface. The rotating mechanism includes a first disk, a second disk and a rotating shaft. The first disk is disposed on the first surface. The second disk is disposed on the second surface. The first disk is connected with the second disk through the rotating shaft. Consequently, the first disk is rotatable relative to the second disk, wherein the second disk is fixed on the base. The supporting mechanism is connected with the rotating mechanism and the point-of-service display, so that the point-of-service display is supported by the base and the point-of-service display is rotatable by the rotating mechanism.

In an embodiment, the rotating shaft is penetrated through the base. The first disk and the second disk at opposite sides of the base are connected with the rotating shaft.

In an embodiment, the supporting mechanism includes a first connecting part and a first pivotal shaft. The first connecting part of the supporting mechanism is pivotally coupled to the rotating mechanism through the first pivotal shaft.

In an embodiment, the supporting mechanism further includes a second connecting part and a second pivotal shaft. The second connecting part of the supporting mechanism is pivotally coupled to the point-of-service display through the second pivotal shaft.

In an embodiment, the first pivotal shaft and the second pivotal shaft are parallel with each other.

In an embodiment, the rotating shaft is axially orthogonal to the first pivotal shaft and the second pivotal shaft.

In an embodiment, the first connecting part of the supporting mechanism is fixedly connected to the rotating mechanism, and the second connecting part of the supporting mechanism is fixedly connected to the point-of-service display.

In an embodiment, the first connecting part of the supporting mechanism is connected to a position near an edge of the rotating mechanism.

In accordance with another aspect of the present invention, there is provided an adjustable connecting seat. The adjustable connecting seat is connected with a point-of-service display. The adjustable connecting seat includes a base, a rotating mechanism, and a movable coupling mechanism. The rotating mechanism is rotatably connected with the base. The movable coupling mechanism includes a first connecting part and a second connecting part. The movable coupling mechanism is pivotally coupled to the rotating mechanism through the first connecting part. The movable coupling mechanism is pivotally coupled to the point-of-service display through the second connecting part.

In an embodiment, the rotating mechanism includes a rotating shaft, wherein the rotating shaft is rotatably penetrated through the base.

In an embodiment, the movable coupling mechanism further includes a first pivotal shaft and a second pivotal shaft. The first connecting part of the movable coupling mechanism is pivotally coupled to the rotating mechanism through the first pivotal shaft. The second connecting part of the movable coupling mechanism is pivotally coupled to the point-of-service display through the second pivotal shaft. Moreover, the first pivotal shaft and the second pivotal shaft are parallel with each other.

In an embodiment, the first connecting part of the movable coupling mechanism is connected to a position near an edge of the rotating mechanism.

In an embodiment, the rotating mechanism includes a rotary disk and a stopper. A first end of the rotating shaft is connected with the rotary disk, and a second end of the rotating shaft is connected with the stopper. A rotating shaft is penetrated through a perforation of the base. Moreover, a cross-sectional area of the stopper is larger than a cross-sectional area of the perforation.

In accordance with a further aspect of the present invention, there is provided a point-of-service device. The point-of-service device includes a point-of-service display and an adjustable connecting seat. The adjustable connecting seat is connected with a point-of-service display. The adjustable connecting seat includes a base and a rotating mechanism. The rotating mechanism includes a first disk, a second disk and a rotating shaft. The first disk is connected with the second disk through the rotating shaft. Consequently, the first disk is rotatable relative to the second disk. The second disk is fixed on the base.

In an embodiment, the adjustable connecting seat further includes a supporting mechanism. The supporting mechanism is connected with the rotating mechanism and the point-of-service display, so that the point-of-service display is supported by the base.

In an embodiment, the base has a first surface and a second surface. The second surface is opposed to the first surface. The first disk of the rotating mechanism is disposed on the first surface. The second disk of the rotating mechanism is disposed on the second surface. The point-of-service display is rotatable by the rotating mechanism.

In an embodiment, the supporting mechanism includes a first connecting part and a first pivotal shaft. The first connecting part of the supporting mechanism is pivotally coupled to the rotating mechanism through the first pivotal shaft.

In an embodiment, the supporting mechanism further includes a second connecting part and a second pivotal shaft. The second connecting part of the supporting mechanism is pivotally coupled to the point-of-service display through the second pivotal shaft.

In an embodiment, the rotating mechanism includes a rotary disk and a stopper. A first end of the rotating shaft is connected with the rotary disk, and a second end of the rotating shaft is connected with the stopper. A rotating shaft is penetrated through a perforation of the base. Moreover, a cross-sectional area of the stopper is larger than a cross-sectional area of the perforation.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the combination of an adjustable connecting seat and a point-of-service display of a point-of-service device according to a first embodiment of the present invention;

FIG. 2 is a schematic perspective view illustrating the combination of the adjustable connecting seat and the point-of-service display of the point-of-service device of FIG. 1, and taken along another viewpoint;

FIG. 3 is a schematic cross-sectional view illustrating the adjustable connecting seat of the point-of-service device according to the first embodiment of the present invention; and

FIG. 4 is a schematic cross-sectional view illustrating an adjustable connecting seat of the point-of-service device according to a second embodiment of the present invention.

### DETAILED DESCRIPTION OF THE PREFERRED EMBODIMENT

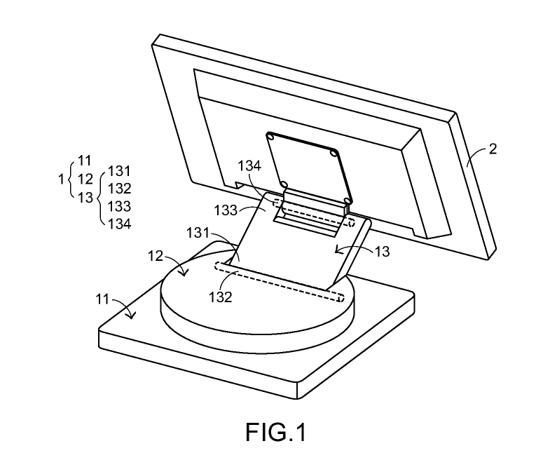

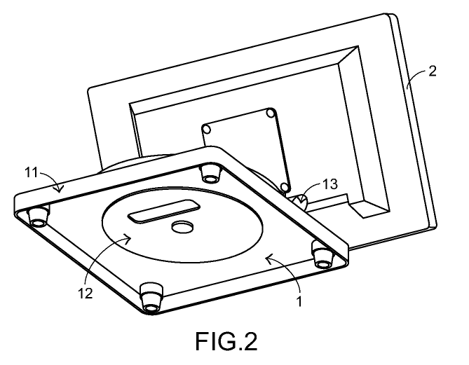

FIG. 1 is a schematic perspective view illustrating the combination of an adjustable connecting seat and a point-of-service display of a point-of-service device according to a first embodiment of the present invention. FIG. 2 is a schematic perspective view illustrating the combination of the adjustable connecting seat and the point-of-service display of the point-of-service device of FIG. 1, and taken along another viewpoint. As shown in FIGS. 1 and 2, the point-of-service device of the present invention comprises an adjustable connecting seat 1 and a point-of-service display 2. In this embodiment, the adjustable connecting seat 1 is combined with the point-of-service display 2. It is noted that the adjustable connecting seat 1 may be combined with other kind of display device.

Please refer to FIGS. 1 and 2 again. The adjustable connecting seat 1 comprises a base 11, a rotating mechanism 12, and a supporting mechanism 13. The rotating mechanism 12 is rotatably disposed on the base 11. In this embodiment, the supporting mechanism 13 is a movable coupling mechanism. Moreover, the supporting mechanism 13 is connected with the rotating mechanism 12. Consequently, the supporting mechanism 13 is rotatable relative to the base 11 through the rotating mechanism 12.

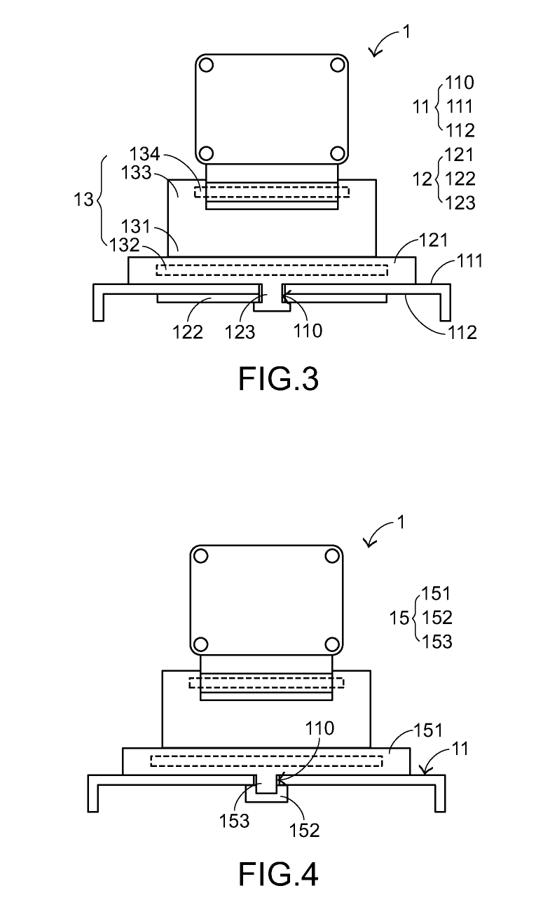

Hereinafter, the detailed structure of the rotating mechanism 12 will be illustrated with reference to FIGS. 1, 2 and 3. FIG. 3 is a schematic cross-sectional view illustrating the adjustable connecting seat of the point-of-service device according to the first embodiment of the present invention. The base 11 has a first surface 111 and a second surface 112, wherein the second surface 112 is opposed to the first surface 111. In a case that the base 11 is placed on a desk, the first surface 111 faces upwardly, and the second surface 112 faces downwardly.

The rotating mechanism 12 comprises a first disk 121, a second disk 122, and a rotating shaft 123. In this embodiment, the first disk 121 and the second disk 122 are disposed on the first surface 111 and the second surface 112 of the base 11, respectively. The rotating shaft 123 is penetrated through a perforation 110 of the base 11. Consequently, the first disk 121 and the second disk 122 at the two opposite sides of the base 11 are connected with each other through the rotating shaft 123. In this manner, the first disk 121 is rotatable relative to the second disk 122. Moreover, since the second disk 122 is fixed on the base 12, the first disk 121 is rotatable relative to the base 11. Since the first disk 121 is contacted with the first surface 111 of the base 11, the pressure supported by the rotating shaft 123 may be partially shared by the first disk 121. Under this circumstance, the use life of the rotating shaft 123 can be prolonged.

It is noted that the relationship between the first disk 121, the second disk 122 and the base 11 is presented herein for purpose of illustration and description only. However, those skilled in the art will readily observe that numerous modifications and alterations may be made while retaining the teachings of the invention. For example, in some other embodiments, the second disk 122 is disposed on the first surface 111 of the base 11, and the first disk 121 is also connected with the second disk 122 through the rotating shaft 123. These modifications and alterations are not redundantly described herein.

Please refer to FIGS. 1, 2 and 3 again. The supporting mechanism 13 is connected with the point-of-service display 2 and the rotating mechanism 12. Consequently, the supporting mechanism 13 is rotatable relative to the base 11 via the rotating mechanism 12. In other words, the point-of-service display 2 that is connected with the supporting mechanism 13 can be rotated leftwards or rightwards, and thus the point-of-service display 2 can be easily adjusted to a desired rotating angle. Under this circumstance, when the point-of-service device is installed on the business place, the space limitation of the business place will be largely reduced, and the space utilization will be enhanced.

Moreover especially, the supporting mechanism 13 and the rotating mechanism 12 may be fixedly or detachably connected with each other. In this embodiment, the supporting mechanism 13 and the rotating mechanism 12 are detachably connected with each other. For example, the supporting mechanism 13 comprises a first connecting part 131 and a first pivotal shaft 132. The first connecting part 131 of the supporting mechanism 13 is pivotally coupled to the rotating mechanism 12 through the first pivotal shaft 132, so that the supporting mechanism 13 is rotatable relative to the rotating mechanism 12. Moreover, the first pivotal shaft 132 is axially orthogonal to the rotating shaft 123. In a case that the supporting mechanism 13 is rotated about the first pivotal shaft 132, the altitude of the point-of-service display 2 that is connected with the supporting mechanism 13 can be adjusted.

Moreover, the supporting mechanism 13 further comprises a second connecting part 133 and a second pivotal shaft 134. The second connecting part 133 of the supporting mechanism 13 is pivotally coupled to the point-of-service display 2 through the second pivotal shaft 134. Consequently, in a case that the point-of-service display 2 is rotated about the second pivotal shaft 134, the point-of-service display 2 is rotatable relative to the supporting mechanism 13. Moreover, the first pivotal shaft 132 is parallel with the second pivotal shaft 134. Consequently, after the altitude of the point-of-service display 2 is adjusted by rotating the supporting mechanism 13 about the first pivotal shaft 132, the vertical orientation of the point-of-service display 2 may be further adjusted by rotating the point-of-service display 2 relative to the supporting mechanism 13. After the altitude and the vertical orientation of the point-of-service display 2 are adjusted by the above adjusting mechanism, the rotating mechanism 12 is further horizontally rotated. Consequently, the point-of-service display 2 may be correspondingly adjusted to a position within the clearly viewable ranges of different users.

Alternatively, in a simplified configuration, the supporting mechanism 13 and the rotating mechanism 12 may be fixedly connected with each other, or the supporting mechanism 13 and the point-of-service display 2 may be fixedly connected with each other. That is, the supporting mechanism 13 is fixedly connected with the rotating mechanism 12 and the point-of-service display 2. Those skilled in the art will readily observe that numerous modifications and alterations may be made while retaining the teachings of the invention. These modifications and alterations are not redundantly described herein.

In some other embodiments, the first connecting part 131 of the supporting mechanism 13 is connected to a position near an edge of the rotating mechanism 12. Consequently, the movable range of the supporting mechanism 13 is expanded.

In the above embodiment, the connection between the base 11 and the rotating mechanism 12 may be implemented when the connection between the first disk 121, the second disk 122 and the rotating shaft 123 are connected with the base 12. It is noted that the way of connecting the base 11 with the rotating mechanism 12 may be varied according to the practical requirements.

FIG. 4 is a schematic cross-sectional view illustrating an adjustable connecting seat of the point-of-service device according to a second embodiment of the present invention. As shown in FIG. 4, the rotating mechanism 15 of the adjustable connecting seat 1 comprises a rotary disk 151, a stopper 152 and a rotating shaft 153. A first end of the rotating shaft 153 is connected with the rotary disk 151. A second end of the rotating shaft 153 is connected with the stopper 152. The rotating shaft 153 is penetrated through a perforation 110 of the base 11. Moreover, the cross-sectional area of the stopper 152 is larger than the cross-sectional area of the perforation 110 in order to avoid detachment of the rotating shaft 153 from the perforation 110. By means of the configurations of FIG. 4, the rotating mechanism 15 is rotatable relative to the base 11. The other components of this embodiment are similar to those of the first embodiment, and are not redundantly described herein.

From the above descriptions, the present invention provides an adjustable connecting seat. The adjustable connecting seat comprises a rotating mechanism and a supporting mechanism. By the rotating shaft of the rotating mechanism and the pivotal shafts of the supporting mechanism, a three-shaft adjustable connecting seat is achieved. Consequently, the rotating angle, the vertical orientation and the altitude of the point-of-service display that is connected with the adjustable connecting seat can be adjusted according to the practical requirements. In a case that the point-of-service device is installed on the business place, the space limitation of the business place will be largely reduced. Under this circumstance, the point-of-service display can be operated at an optimized position. Moreover, since the point-of-service display can be adjusted at a higher degree of freedom, the rotating angle, the vertical orientation and the altitude of the point-of-service display can be adjusted by different users.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An adjustable connecting seat connected with a point-of-service display, said adjustable connecting seat comprising:
a base having a first surface and a second surface, wherein said second surface is opposed to said first surface;
a rotating mechanism comprising a first disk, a second disk and a rotating shaft, wherein said first disk is disposed on said first surface, said second disk is disposed on said second surface, and said first disk is connected with said second disk through said rotating shaft, so that said first disk is rotatable relative to said second disk, wherein said second disk is fixed on said base; and
a supporting mechanism connected with said rotating mechanism and said point-of-service display, so that said point-of-service display is supported by said base and said point-of-service display is rotatable by said rotating mechanism.

2. The adjustable connecting seat according to claim 1, wherein said rotating shaft is penetrated through said base, wherein said first disk and said second disk at opposite sides of said base are connected with said rotating shaft.

3. The adjustable connecting seat according to claim 1, wherein said supporting mechanism comprises a first connecting part and a first pivotal shaft, wherein said first connecting part of said supporting mechanism is pivotally coupled to said rotating mechanism through said first pivotal shaft.

4. The adjustable connecting seat according to claim 3, wherein said supporting mechanism further comprises a second connecting part and a second pivotal shaft, wherein said second connecting part of said supporting mechanism is pivotally coupled to said point-of-service display through said second pivotal shaft.

5. The adjustable connecting seat according to claim 4, wherein said first pivotal shaft and said second pivotal shaft are parallel with each other.

6. The adjustable connecting seat according to claim 5, wherein said rotating shaft is axially orthogonal to said first pivotal shaft and said second pivotal shaft.

7. The adjustable connecting seat according to claim 1, wherein said first connecting part of said supporting mechanism is fixedly connected to said rotating mechanism, and said second connecting part of said supporting mechanism is fixedly connected to said point-of-service display.

8. The adjustable connecting seat according to claim 1, wherein said first connecting part of said supporting mechanism is connected to a position near an edge of said rotating mechanism.

9. An adjustable connecting seat connected with a point-of-service display, said adjustable connecting seat comprising:
a base;
a rotating mechanism rotatably connected with said base; and
a movable coupling mechanism comprising a first connecting part and a second connecting part, wherein said movable coupling mechanism is pivotally coupled to said rotating mechanism through said first connecting part, and said movable coupling mechanism is pivotally coupled to said point-of-service display through said second connecting part.

10. The adjustable connecting seat according to claim 9, wherein said rotating mechanism comprises a rotating shaft, wherein said rotating shaft is rotatably penetrated through said base.

11. The adjustable connecting seat according to claim 9, wherein said movable coupling mechanism further comprises a first pivotal shaft and a second pivotal shaft, wherein said first connecting part of said movable coupling mechanism is pivotally coupled to said rotating mechanism through said first pivotal shaft, and said second connecting part of said movable coupling mechanism is pivotally coupled to said point-of-service display through said second pivotal shaft, wherein said first pivotal shaft and said second pivotal shaft are parallel with each other.

12. The adjustable connecting seat according to claim 9, wherein said first connecting part of said movable coupling mechanism is connected to a position near an edge of said rotating mechanism.

13. The adjustable connecting seat according to claim 9, wherein said rotating mechanism comprises a rotary disk and a stopper, wherein a first end of said rotating shaft is connected with said rotary disk, and a second end of the rotating shaft is connected with said stopper, wherein a rotating shaft is penetrated through a perforation of said base, and a cross-sectional area of said stopper is larger than a cross-sectional area of said perforation.

14. A point-of-service device, comprising:
a point-of-service display; and
an adjustable connecting seat connected with a point-of-service display, and comprising:
a base; and
a rotating mechanism comprising a first disk, a second disk and a rotating shaft, wherein said first disk is connected with said second disk through said rotating shaft, so that said first disk is rotatable relative to said second disk, wherein said second disk is fixed on said base.

15. The point-of-service device according to claim 14, wherein said adjustable connecting seat further comprises a supporting mechanism, wherein said supporting mechanism is connected with said rotating mechanism and said point-of-service display, so that said point-of-service display is supported by said base.

16. The point-of-service device according to claim 14, wherein said base has a first surface and a second surface, wherein said second surface is opposed to said first surface, wherein said first disk of said rotating mechanism is disposed on said first surface, said second disk of said rotating mechanism is disposed on said second surface, and said point-of-service display is rotatable by said rotating mechanism.

17. The point-of-service device according to claim 14, wherein said supporting mechanism comprises a first connecting part and a first pivotal shaft, wherein said first connecting part of said supporting mechanism is pivotally coupled to said rotating mechanism through said first pivotal shaft.

18. The point-of-service device according to claim 17, wherein said supporting mechanism further comprises a second connecting part and a second pivotal shaft, wherein said second connecting part of said supporting mechanism is pivotally coupled to said point-of-service display through said second pivotal shaft.

19. The point-of-service device according to claim 14, wherein said rotating mechanism comprises a rotary disk and a stopper, wherein a first end of said rotating shaft is connected with said rotary disk, and a second end of the rotating shaft is connected with said stopper, wherein a rotating shaft is penetrated through a perforation of said base, and a cross-sectional area of said stopper is larger than a cross-sectional area of said perforation.
